(19) United States
(12) Patent Application Publication
(10) Pub. No.: US 2014/0279045 A1
(43) Pub. Date: Sep. 18, 2014

(54) CROSS-DOMAIN ID SYNCHRONIZATION IN ONLINE ADVERTISEMENT

(71) Applicant: TURN INC., Redwood City, CA (US)

(72) Inventor: Jonathan SHOTTAN, San Francisco, CA (US)

(21) Appl. No.: 14/103,815

(22) Filed: Dec. 11, 2013

Related U.S. Application Data
(60) Provisional application No. 61/800,471, filed on Mar. 15, 2013.

(51) Int. Cl. G06Q 30/02

(52) U.S. Cl. CPC G06Q 30/0269
USPC 705/14.66

(57) ABSTRACT

Disclosed is a computer-implemented method for audience ID synchronization in a data management platform. In one embodiment, the method includes receiving a first redirect traffic from a first domain during a first browser session, in response to a web browser loading an embedded web object on a web page of the first domain; identifying a consumer user by searching through a cookie cache of the web browser to determine whether an unity identifier has been assigned in the cookie cache by the data management platform; in response to determining no unity identifier has been assigned to the consumer user, generating a cookie containing a new unity identifier and dropping the cookie in the cookie cache of the web browser; and synchronizing identifiers for the consumer user with a partner platform by updating a matching table of the identifiers with either the identified unity identifier or the new unity identifier.

### CROSS REFERENCE TO RELATED APPLICATIONS

This application claims priority to U.S. provisional patent application Ser. No. 61/800,471, filed Mar. 15, 2013, which application is incorporated herein in its entirety by this reference thereto.

### TECHNICAL FIELD

The invention relates to on-line advertising. More particularly, the invention relates to cross domain synchronization in an on-line advertising environment.

### BACKGROUND

In online advertisement, a Data Management Platform (DMP) framework functions to give marketers a complete picture of potential customer segments. The DMP supports various cookie space/domains, different types of partners, such as Data Providers (DPs) and Media Providers (MPs), and connects to the various inventory sources via a demand-side media platform and other Media Providers. A DMP has to handle a large amounts of audience data while ensuring that these audiences can be reached (i.e., capable of being act upon). A DMP relies on the ability for advertisers to find these audiences at the different inventory sources through the various partners so that media can be purchased to target the audiences. The need for identifying the users across all these platforms and partners remain a constant challenge. It is many DMP's goal in online advertisement to increase, maintain and monitor audience reach.

The DMP creates audience segments (i.e., similar subgroups based on defined criterion such as product usage, demographics, behavior, media usage, and etc.) by combining proprietary and third party data to track, control, manage, and leverage audience profiles. The DMP can facilitate an advertiser's campaign to reach targeted audience, can increase traction for existing users of the audience platform, can leverage broad audience reach to gain new customers for all advertisers utilizing the audience platform, and can increase revenue for data provider and media provider partners. Many of these benefits rely on the DMP and systems in the online advertisement system environment to work together to collect and consolidate audience user data coherently. However, because the DMP is connected to various data providers, media providers, audience segments, demands side platforms, supply side platforms, and other online advertisement stakeholders to enable a single marketplace for any advertiser to reach target audience, frequent data updates and multiple data update channels are difficult to be maintained to provide a coherent data sharing environment.

### SUMMARY

Disclosed is a technique for cross domain synchronization through a data management platform. The disclosed DMP (referred to as “audience platform”) does not natively generate client-side traffic. Hence, audience identifier synchronization in the audience platform is based on passive, partner initiated traffic. To increase audience reach for the audience platform, the high traffic monitored by the audience platform is built into a robust system with network effect to maximize audience reach coverage with all the partners of the audience platform.

The audience platform manages one or more online domains (hereinafter “managed domains”), such as website domains and subdomains. The audience platform monitors the ingestion of data and the transfer of data on these managed domains. For example, turn.com can be part of the managed domains, which Turn Inc., as a company owning the website domain, operates and manages. Ingestion of data, for example, can include displaying creating a pixel from a web server of the audience platform on a webpage of the managed domain. For example, a pixel linked to a private domain, such as “d.dd.turn.com”, can be considered as natively ingested data in the turn.com domain. When a consumer audience user comes across and downloads the ingested data (e.g., the pixel), a turn.com cookie is uploaded to the consumer audience user's browser to track the audience user, and an audience user profile is thus associated with the turn.com domain on the audience platform. A consumer audience user is a user that is being targeted as an audience to an advertisement on one of the managed domains.

The audience platform may have associated private domains acting as its clients. For example, client private domains may include Experian or Accuen. Each client private domain receive data events from a huge selection of consumer audience users. Each of these private domains can have a separate cookie space for tracking users, data partners, and managed domains. Data events are real-time user-related events occurring on an audience user's browser that is captured and reported by a variety of manners, including embedded web objects (e.g., container tag, tracking pixel, web beacon, page tag, tracking bug, or other ways of embedding an object on a web page or email to allow for checking whether a user has viewed the page). Data events can be shared with the audience platform to process these data events. For example, the private domain can include p-dd.com or audienceIQ.com.

The private domains can be effectively another instance of the DMP. Any pixel to be displayed on an audience user's browser is created with such private domain, and the data is adjusted natively to the private domain. A cookie that is dropped on the audience user's browser cache would be from that private domain as well. The private domain can also create profiles for audience users observed by the private domain.

The disclosed cross domain synchronization enables a single identifier for an audience entity, such as a single audience user or an audience user group. The single identifier can be referred to as a unified ID. The unified ID can be used to facilitate transfer of knowledge relating to the audience entity through online linkages between entities tracked by different domains, including the audience platform and private domains associated with the audience platform.

The audience platform as a data management platform thus can link and associate with various online private domains to establish a larger data exchange network for broadening audience reach. The building and propagation of a matching table storing the linkages between entities tracked by associated private domains enables the unified ID synchronization (or “ID sync”) to occur.

A managed domain can redirect the audience user to the audience platform from one of its webpages. The redirection can occur from firing of an embedded web object in the managed domain. In response to the redirection, the audience platform can attempt to identify the audience user by reading its browser cache to look for a unified ID. If the unified ID does not exist, it is created and placed as a cookie in the browser cache. The unified ID that is either identified or just created, is then associated with audience data retrieved from the managed domain. A mapping to associate the unified ID a domain specific identifier from the managed domain can be saved onto a matching table in a linkage file.

The sharing of the audience user's domain specific identifier can be done asynchronously. For example, the firing of the embedded web object is done on a user session by user session basis. The cross domain synchronization, however, can either be initiated in response to the firing or be initiated on a periodic or otherwise asynchronous manner by logging any previously unknown identifier from session to session, and then updating and sharing the matching table associated with these unknown identifiers to servers of domains associated with the audience platform.

Some embodiments of the invention have other aspects, elements, features, and steps in addition to or in place of what is described above. These potential additions and replacements are described throughout the rest of the specification

### BRIEF DESCRIPTION OF THE DRAWINGS

FIG. 1 is a control flow diagram illustrating an data exchange system architecture for online advertisement implementing a technique of synchronizing audience IDs in accordance with various embodiments.

FIG. 2 is a control flow diagram illustrating an online advertisement system environment in accordance with various embodiments.

FIG. 3 is a block diagram illustrating a data management platform system in accordance with various embodiments.

FIG. 4 is a block diagram illustrating a match table including multiple cookie spaces used to perform ID synchronization of audience identifiers in accordance with various embodiments.

FIG. 5 is a flow chart illustrating a method of operating a data management platform to asynchronously synchronize audience identifiers across domains.

FIG. 6 is a diagrammatic representation of a machine in the example form of a computer system within which a set of instructions, for causing the machine to perform any one or more of the methodologies or modules discussed herein, may be executed.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Definitions

Cookies are pieces of code that web servers use to put information on a user's browser for subsequent retrieval. For example, Turn.com can set a cookie on a user's browser to remember a user's geographic location and demographic profile. Cookies can be privacy conscious by design, so often times only the server domain that sets a cookie is able to retrieve the cookies. For example, ad servers use cookies to set unique IDs so the ad servers can identify the same user across multiple touch points. When an ad server receives an ad display request from a user who does not have an existing cookie, the ad server assigns a new unique ID (a random alpha-numeric string such as 12345ABCDE). On each subsequent request the cookie returns the same unique ID, thus allowing the ad server to know that it is the same user. Because all requests are recorded by the ad server, reports can be created that provide a record of all the touchpoints for each user.

Click Redirects: for media running outside of the ad server, such as paid search, one approach is to apply click redirects within the URL. The click redirects briefly send the user's browser through to the ad server to be cookied and then return the user's browser back out to a desired landing page. This happens in a fraction of a second and is barely perceptible by the user. Because that intermediate hop is on the ad server domain, the ad server domain can log the data needed to record and read the cookie for the unique ID.

Pixel Tags: for media without a click event (such as navigating to a site directly), click redirects cannot be used. In those cases, the solution is to use pixel tags (also known as tags, 1×1 pixels or web bugs). Pixel tags are typically single pixel, transparent GIF images that are added to a web page. Even though the pixel tag is virtually invisible, it is still served just like any other image one may see online. The trick is that the web page is served from the site's domain while the image is served from the ad server's domain. This allows the ad server to read and record the cookie with the unique ID and the extended information the server domain needs to record.

Container tags: Tag containers hold browser side executable code (e.g., JavaScript code) which contains one or more pixel or click tags. These tag containers can control the information being passed into images, and can decide whether or not to “fire” or show the image tag, which would trigger the ad server to record an impression with the unique ID. A common use for tag containers is to tag users from unpaid impressions, such as organic search visits and direct traffic. An attribution process often uses JavaScript to record the referring URL or other information needed to identify and record otherwise untracked conversion paths.

User engagement tracking: there exist other technologies used to track user engagement stacks for attribution measurement. Once all the touchpoints for a user are recorded in an online advertisement system environment, attribution modules or systems can consume the log files that ad servers provide to do the work necessary to appropriately assign fractional credit to each touchpoint that contributed to a desired outcome.

FIG. 1 is a control flow diagram illustrating an data exchange system architecture 100 for online advertisement implementing a technique of synchronizing audience IDs in accordance with various embodiments. The data exchange system architecture 100 includes an audience platform 102. The audience platform 102 can be a data management platform responsible for creating audience segments to facilitate targeted advertisement data tracking. The audience platform 102 can also be part of a media purchase service platform. The audience platform 102 can be implemented by a computer system, including one or more computer servers. The audience platform 102 includes an audience database 104 that keeps track of audience identifiers 106 each associated with at least one of analytical user profiles (AUPs) 108. The audience identifiers 106 represent audience users monitored and analyzed by the audience platform 102. The AUPs 108 can include behavior data, behavior trend, impression data, predictive analytic, intent data, or any other data to facilitate targeted advertisement.

The audience platform 102 can be in real time or periodic communication with various computer systems in the data exchange system architecture 100. For example, the audience platform 102 can communicate with one or more demand side providers 112, one or more data providers 114, one or more advertisers 116, one or more media providers 118, or other computer systems capable of collecting data related to audience users (e.g., interaction history, behavior, demographics, intent, etc.). The computer systems can communicate with each other by establishing an application interface. A computer system in the data exchange system architecture 100 can also communicate via embedded objects within a web service domain controlled by the computer system. When an audience user reaches a particular part of the web service domain (e.g. a webpage or a step in an interactive web script process), the computer system can cause part of its domain specific information to pass onto the audience platform 102 through a pixel call, or more generally, a web redirect based on an embedded object on a webpage.

The audience platform 102 can include a data intake module 110, which is configured to process incoming data events 122, such as an embedded pixel fire 122A, an embedded pixel fire 122B, an embedded pixel fire 122C, or an embedded pixel fire 122D (collectively as “incoming data events 122”), redirected from associate web domains of the audience platform 102. The incoming data events 122 can be part of the traffic visiting the associate web domains. The embedded pixel fire 122A, for example, can be a pixel call redirect from one of the demand-side providers 112 providing impression and click data of advertisements presented to audience users. The embedded pixel fire 122B, for example, can be a pixel call redirect from one of the data providers 114 sending any form of audience user related data to the audience platform 102. The embedded pixel fire 122C, for example, can be a pixel call redirect from one of the advertisers 116 sending data related to feedback and/or interaction with the audience users. The embedded pixel fire 122D, for example, can be a pixel called redirect from one of the media providers 118 sending media viewing behaviors of the audience users.

In various embodiments, the data intake module 110 can also process batch audience data synchronization messages from the various computers systems. For example, audience data including audience user identifiers from the various computer systems can be sent in batch through an application interface coupled to the data intake module 110.

Based on the incoming data events 122 received, the data intake module 110 can update a linkage entry in a matching table 130 mapping domain specific identifiers of audience users from various computer systems in the data exchange system architecture 100. For example, the matching table 130 can flag linkages of previously unknown identifiers or newly generated identifiers (collectively as “new identifiers 134”). The audience platform 102 can include a cross domain synchronization module 138.

Domain synchronization module 138 can then send server to server messages 140 from the audience platform 102 to each of the other computer systems in the data exchange system architecture 100. In this manner, the computer systems, other than the audience platform 102, can preserve data coherency without needing to always synchronize in real-time with multiple computer systems, based on every incoming data event. The server to server messages 140 can be sent periodically or other asynchronous manner. In some embodiments, in response to each of the incoming data events 122, the cross domain synchronization module 138 can return the updated linkage from the matching table 130 immediately to certain web domains with high priority in the data exchange system architecture 100.

In some embodiments, the cross domain synchronization module 138 can also synchronize the audience identifiers and/or platform identifiers of the various computer systems with private domain partners 142. Identifiers known to the private domain partners 142 can be sent to the audience platform 102. Alternatively, the audience platform 102 can send identifiers known to the audience platform 102 to the private domain partners 142.

FIG. 2 is a control flow diagram illustrating an online advertisement system environment 200 in accordance with various embodiments. The system environment 200 includes advertisers 202 on one side and audience 204 on the other. The advertisers 202 can purchase advertisement opportunities through an advertisement agencies 206. The advertisement agencies 206 manually or automatically work with the advertisers 202 to select available media channels to present advertisements of the advertisers 202. In some cases, the advertisement agencies 206 communicate with agency trade desks (ATDs) 208 to facilitate buying of media channels.

An agency trade desk is a centralized, service-based organization that serves as a managed service layer, typically on top of a licensed demand-side platform (DSP), such as one of the DSPs 210, and other audience buying technologies. The agency trade desk manages programmatic, bid-based media and audience buying. The agency trade desk can support advertisement agencies by enabling a dynamic way to purchase audiences. That is, the agency trade desk allows media to be purchased in real time rather than from pre-procured inventory through, for example, an auction based model.

The demand-side platform is a system that allows buyers of digital advertising to manage multiple advertisement exchanges 212 and data exchange accounts through a single interface. The demand-side platforms 210 can manage bids by advertisers, including proper pricing of the bids, to the advertisement exchanges 212. An advertisement exchange is an online marketplace for real-time bidding of presenting online ads through media channels. Optionally, the advertisement exchanges 212 can also work directly with the agency trade desks 208 to receive real-time bids.

One source of identifying media channels for presenting the advertisements is through advertising networks 214. An advertising network is a company that connects advertisers to web domains that want to host advertisements. The key function of the advertising network is aggregation of ad space supply from different publishers and matching such advertisement space (“ad space”) supply to advertiser demand. On the demand-side, the advertising networks 214 can work with the demand-side platforms 210 or the advertisement exchanges 212. On the supply side, the advertising networks 214 can work with supply-side platforms 216. The supply-side platforms 216 are technology platforms that can enable publishers 218 to manage ad impression inventory and maximize revenue from digital media. A supply-side platform can communicate the media spaces available from its publishers on the advertisement networks 214 and/or the advertisement exchanges 212 to sell the media spaces on those platforms. Alternatively, the publishers 218 can work directly with the advertisement exchanges 212. In turn, the publishers 218 having sold part of their online media space for advertisement, present the advertisements to the audiences 204.

An addition to the flow of online targeted advertisement is a data management platform 220, such as the audience platform 102 of FIG. 1. The data management platform 220 is a centralized data management system that enables advertisers or their agents (e.g., the advertisement agencies 206, the ATDs 208, or the demand side platforms 210) to create target audiences based on a combination of in-depth first party and/or third-party audience data to accurately target advertisement campaigns to these audiences across the advertising networks 214 and the advertisement exchanges 212.

The data management platform 220 can create audience segments, which are groups of available media channels in an inventory indicating how to reach certain types of audience. The data management platform 220 is in communication with various data providers 224. In addition, the data management platform 220 can be in communications with various media providers 226. Some of the media providers 226 can be the publishers 218. By aggregating, consolidating, and analyzing the data provided to the data management platform 220 through the data providers 224, the media providers 226, the advertisers 202, and/or other data sources, the data management platform 220 can accurately create the audience segments to be sold to the advertisers 202. The data management platform 220 can be any information exchange platform for buying and selling information necessary to identify specific target audience for advertisement campaigns.

Aside from the data management platform 220, which keeps track of audience user profiles, other systems within the online advertisement system environment 200 also track and collect user related data that may be essential to improving audience reach and to gaining new customers. The disclosed technique for cross-domain ID synchronization enables the proper sharing of these audience user profiles by creating a way of mapping user identifiers from one system to another. Even if one of the systems in the system environment 200 is willing to share its information, other systems would not be able to correctly utilize and integrate the information without the proper mapping.

FIG. 3 is a block diagram illustrating a data management platform 300 in accordance with various embodiments. The data management platform 300 can be a computer system, including one or more computer servers. The data management platform 300 includes an application interface 302, a data management module 304, a data integration module 306, and a web server 308. The application interface 302 is configured to communicate with various computer systems connected to the data management platform 300, such as the demand-side platforms 112, the data providers 114, the advertisers 116, and the media providers 118 of FIG. 1. These computer systems that serve as data sources for audience data synchronization can be collectively referred to as “audience data partners.”

In various embodiments, the data management module 304 can be configured to perform data analysis including calculating analytics, insights, and/or correlations in relation to audience users for an online advertisement system environment, such as the online advertisement system environment 200 of FIG. 2. The data management module 304 includes a data intake module 310, which is configured to facilitate data intake and to perform data inventory (i.e., categorizing and accounting for specific domain user data in relation to specific audience). The data intake can come from the application interface 302 or the web server 308. The web server 308 hosts a website that is capable of receiving redirects from a partner web domain, such as through a tracking pixel fire, a container tag, or other embedded web objects. The web server 308 communicates with a consumer browser that has visited the partner web domain and activated the embedded web object. The data inventory can be stored in a data inventory database 312.

The data intake module 310 can be coupled with the application interface 302, which collects audience user related data from a variety of data providers, including social data (e.g., Facebook™, Twitter™, YouTube™, or other social media websites), consumer intent data (i.e., a data source indicating that a particular audience user/consumer is interested in a particular category of product or services), device data (e.g., a data source collecting user behavior and profile from mobile devices), off-line data sources, advertisement server data sources, search engine data sources, email based data sources, website analytics data sources, user generated content data sources, or any combination thereof. The application interface 302 can be an application programming interface that corresponds with the data sources or a communication interface that queries information from application programming interfaces of the data sources.

The data intake module 310 can also be configured to manage metadata in relation to the data intake, including management of tags on the data inventory. In various embodiments, the data management module 304 includes a data security module 314 for managing data access rights and data protection mechanisms of the data inventory database 312. In various embodiments, the data management module 304 includes a segmentation module 316, which is configured to segment available audience channels based on the data inventory and/or the data analysis of the data inventory. In various embodiments, the data management module 304 can be further configured to establish attribution, via a set of rules that determines how credit for a conversion associated with an advertisement is assigned to each publisher presenting the advertisement.

In various embodiments, the data management platform 300 also includes an audience management module 318, which is configured to facilitate audience reach. For example, the audience management module 318 can work with other computer systems in the online advertisement system environment to perform audience development, audience verification, audience optimization, and/or audience extension.

Under the disclosed technique of cross-domain synchronization, the data integration module 306 is configured to normalize, integrate, and consolidate data across the data inventory. For example, the data integration module 306 can perform server-to-server user identifier matching by use of a matching table in a match table database 320, such as the matching table 130 of FIG. 1. The data integration module 306 can include session-based updates, API-based updates, and batch updates to data partners of the data management platform 300. The session-based updates, for example, may include firing of one or more redirects from the web server 308 to cause the consumer browser to visit a web domain of a data partner. Data can be transferred through the redirect calls or through cookies injected into the consumer browsers. The API-based updates, for example, may include sending user data, such as the matching table 320, through the application interface 302. The batch update, for example, may be a periodic server-to-server update of one or more matching tables in the match table database 320.

Blocks, components, and/or modules associated with the data exchange system architecture 100, the system environment 200, and data management platform 300 may be implemented as hardware modules, software modules, or any combination thereof. For example, the modules described can be software modules implemented as instructions on a tangible storage memory capable of being executed by a processor or a controller on a machine. The tangible storage memory may be a volatile or a non-volatile memory. In some embodiments, the volatile memory may be considered “non-transitory” in the sense that it is not a transitory signal. Software modules may be operable when executed by a processor or other computing device, e.g., a single board chip, application specific integrated circuit, a field programmable field array, a network capable computing device, a virtual machine terminal device, a cloud-based computing terminal device, or any combination thereof.

Each of the modules may operate individually and independently of other modules. Some or all of the modules may be executed on the same host device or on separate devices. The separate devices can be coupled via a communication module to coordinate its operations via an interconnect or wirelessly. Some or all of the modules may be combined as one module.

A single module may also be divided into sub-modules, each sub-module performing separate method step or method steps of the single module. In some embodiments, the modules can share access to a memory space. One module may access data accessed by or transformed by another module. The modules may be considered “coupled” to one another if they share a physical connection or a virtual connection, directly or indirectly, allowing data accessed or modified from one module to be accessed in another module. In some embodiments, some or all of the modules can be upgraded or modified remotely. Each of the system architecture, system environment, and platform system may include additional, fewer, or different modules for various applications.

FIG. 4 is a block diagram illustrating a match table including multiple cookie spaces used to perform ID synchronization of audience identifiers in accordance with various embodiments. As exemplified in FIG. 4, the matching table 400 can include a first cookie space 402 and a second cookie space 404. Each cookie space can include a number of columns and rows. For example, in the first cookie space 402 there are four columns of audience identifiers. The columns correspond to web domains 408. The rows correspond to audience entities 410, such as audience users or audience groups. The audience identifiers can be found in browser cookie caches to uniquely identify an audience user when the audience user is browsing one of the specific web domains. Each of the specific web domain can build an entity profile associated with a specific audience identifier. When data becomes available from one domain to another, such as by server to server data sharing or by domain-to-domain web redirection, each row of the matching table 400 can provide the linkage necessary to consolidate the entity profiles across multiple web domains.

Different cookie spaces may represent different data exchange networks that allows for redirections between the domains of the data exchange networks. The matching table 400 can include more than one cookie spaces, such that, when necessary, audience identifier (and associated audience profiles) can be shared even between different data exchange networks to expand audience reach. Some cookie spaces may share certain web domains. For example, the first cookie space 402 and the second cookie space 404 can both have “Domain #2.” In some embodiments, the same audience entity reported through the same web domain can have the same audience identifier across different cookie spaces. In other embodiments, the same audience entity reported through the same web domain can have different audience identifiers across different cookie spaces.

FIG. 5 is a flow chart illustrating a process 500 of synchronizing audience user IDs across domains. The process 500 can be executed on a data management platform. The process 500 begins with receiving a first redirect data traffic from a first web domain during a first browser session of a web browser at step 502. The first redirect traffic can be sent in response to the web browser loading an embedded web object on a web page of the first domain. Step 502 is performed by a computer system, such as the computer system 600 of FIG. 6. The computer system, for example, can be the data management platform 220 or the demand side platform 210 of FIG. 2, the audience platform 102 of FIG. 1, or the data management platform 300 of FIG. 3.

The embedded web object can be a tracking pixel or a container tag. The embedded web object can report an audience user event of a consumer user associated with the first browser session. The audience user event of which triggers the redirect data traffic can include an audience user impression, a media provider beacon, a data provider collection pixel being fired during the first browser session, a media provider container tag being fired, or an advertiser data collection pixel being fired. The first web domain can be an audience data source, such as a website domain of a data provider, a media provider, an advertiser, a demand side platform, a private domain, another data management platform, an advertisement publisher, or other entities within the online advertisement system environment.

In response to receiving the redirect traffic, the data management platform can identify the consumer user by searching through a cookie cache of the web browser to determine whether an unity identifier has been assigned in the cookie cache by the data management system in step 504. The unity identifier is a single identifier used in a matching table to transfer knowledge of online linkages between entities observed by various web domains and/or data management platforms. If it is determined that no unity identifier has been assigned to the consumer user, a cookie containing a new unity identifier is generated and dropped into the cookie cache of the web browser in step 506.

In some embodiments, a user profile (e.g., a run-time user profile and/or an analytical user profile) is updated on the data management platform in response to the first redirect traffic in step 508. The user profile may be associated with the single unity identifier. As part of the disclosed technique for cross domain ID synchronization, the process 500 includes step 510 where the data management platform can synchronize identifiers of the consumer user with one or more partner platforms by updating a matching table of the identifiers with either the identified unity identifier or the new unity identifier. The synchronization of the identifiers (“ID sync”) can be performed as a server-to-server message or as a run-time ID sync call from the data management platform to the partner platforms, in response to receiving the first redirect traffic. For example, the run-time ID sync call can be a browser-side redirect to a synchronization URL.

The synchronization of the identifiers can be done through an ID sync call. The ID sync call can be sent over to a specific uniformed resource locator (URL) of the partner platform. In some embodiments, the majority of audience data partners that serve as the audience data sources to the data management platform allow the ID mapping in the matching table to be stored on the data management platform. Therefore, when the data management platform calls the ID syncing URL of the platform partner, the data management platform has to wait for a response and write an audience identifier corresponding to the unity identifier of the consumer user to the user profile of the consumer user.

The disclosed technique for audience identifier synchronization can apply to any computer system in the online advertisement system environment, such as the system environment 200 of FIG. 2. The audience identifier synchronization can apply to different traffics between/amongst the computer systems of the system environment, each computer system profiling audience entities from its web domain. Accordingly, the cross domain synchronization module 138 of FIG. 1 can be part of a framework callable by various other modules in the computer systems of the system environment. The types of traffic that can trigger an audience identifier synchronization and an update of the matching table can include: impression traffic and beacon traffic from the media providers or the supplier side platforms; data collection pixel fires from data providers based on a data contract; data collection pixel fires from advertisers based on advertiser data contract; and data collection pixel and container tag fires from media provider.

For each of the source of traffic, the cross domain synchronization module can capture the following properties: (1) whether the traffic source allows re-direct; (2) if the traffic source allows re-direct, what is the max number of re-direct; (3) whether the traffic source allows re-direct outside the current cookie space; (4) does the incoming user traffic uses http or https; and (5) what is the geographical location of the incoming user traffic by region, such as country, zip code, or continent.

The audience data partners can be classified into groups and prioritize according to its classification. The priority of the audience data partners can be used to determine the frequency of the identifier synchronization in the order in which identifier synchronization is carried out. For example, the audience data partners can be classified as below listed in an exemplary priority order: (1) real-time bidding (RTB) exchanges (e.g., OpenX or Admeld); (2) Non-RTB Exchanges (e.g., RMX or AdX), such as to send all behaviors for an audience user that an impression is served on to these partners); (3) private domains connected to the data management platform (e.g., AIP or AIQ); (4) media providers (e.g., Invite Media or Media Math); and (5) data providers (e.g., eXelate). For each of the audience data partners, the cross domain synchronization module can capture the following: (a) class of partner; (b) which of the computer system in the system environment will store the audience identifier matching table; (c) the audience data partner's identifier synchronization URL (e.g., either prefixed with http or https); (d) geographical location of the audience data partner; and (e) time to live (TTL) for the identifier synchronization (e.g., 7, 14, 30 days).

In some embodiments, in order not to increase latency of the calls, each traffic event (for example, a single impression serve traffic call) can only call up to a maximum of 1 of URL of the partner platforms (assuming maximum limit of re-directs for the audience data source, if specified, have not be reached yet). The limit on run-time ID sync keeps latency related to the ID sync at a minimum. In various embodiments, a throttling mechanism can also be implemented to control the load of ID syncing by the data management platform. The throttle mechanism can control number of ID sync calls to the partner platforms.

The synchronization of the identifiers can be performed asynchronous in an offline manner. For example, the matching table, stored either on the data management platform or one or more partner platforms, can be updated when the data management platform receives a server-to-server update message. The server-to-server update message can include data (e.g., demographic, behavior history, advertisement interaction history, etc.) to update the user profile as well as audience identifiers for identifying an audience user related to the data. When an offline ID sync fills an ID mapping (e.g., the matching table) of a consumer user, the data management platform can update the date used in time to live (TTL) of the consumer user's runtime profile. For this offline process to work, the data management platform stores a platform mapping between media providers and data providers in various cookie spaces. A cookie space is a set of web domains with web-based re-directions setup in their webpages to access information stored on cookie caches of consumer users' browsers. A platform system in a first cookie space mutually exclusive to a second cookie space cannot access the information stored by web domains in the second cookie space.

For example, eXelate can be a data provider in both the cookie space for Audience Intelligence Platform (AIP) of Accuen and in the Turn.com cookie space. A data provider ID for eXelate in AIP can thus be different from the data provider ID for eXelate in Turn.com. Hence, a platform mapping stores an identifier for a platform partner in one cookie space, and maps to that same partner's various IDs for the various other cookie spaces.

During the copying of the partner IDs from one domain to another, the data management platform can support the following types of access: (a) ID sync can be copied without restriction (e.g., when copying data partner IDs); (b) ID syncs that can be copied, but only visible to internal admin users of the data management platform (e.g., when copying an audience user ID of a private domain partner into an analytical user profile of another private domain partner); and (c) ID syncs that can not be copied. In various embodiments, queries by a private domain partner on partner IDs cannot return user info from another private domain partner.

A web server service of the data management platform can server a monitoring page that displays a view of audience reach by partner and by cookie space/domain. The monitoring page can measure the daily runtime syncing as well as the daily batch ID syncing to express audience reach coverage. Total reach can be calculated for the data partners (e.g., data providers and media providers) where the data management platform stores the audience user IDs from the data partners. The monitoring page can be part of the audience platform monitoring tools and available through a URL under a web domain of the data management platform.

The monitoring page can capture, in accordance with a data partner's agreement with the data management platform, whether the data partner is to store audience user IDs for particular cookie spaces, or the data management platform is to store the partner's audience user IDs. The information can be viewable by Cookie Space or by Country (e.g., US, UK, FR, etc.) and filterable by time (e.g., today, yesterday, last week, last 30 days, or all time).

The aggregation of the audience reach coverage can be done daily. A forecast server can be used on the audience reach coverage aggregation.

A notification (e.g., by email) can be generated based on monitoring numbers of one or more data partners, such as by a determining whether a percentage of audience IDs being synchronized falls below a threshold percentage for a given partner, cookie space, or country). For example, a notification email can be sent if ID synchronization of the data partner “TubeMogul” falls below 65%.

In various embodiments, the matching table or other ID mapping data can be stored in a single place in an analytic user profile data storage of the data management platform. For example, source of the last ID mapping made in the data management platform can be stored. This can allow analytics to be run to determine business needs, such as the value of particular match partners, etc. The ID mapping URLs (e.g., http or https) for each partner the data management platform have to call can also be stored. Each partner can be labeled as a “source of traffic” (i.e., redirect traffic to the data management platform) and/or a “partner to call” (i.e., to ID sync with). The type of each traffic source (e.g., Publisher, Inventory source, Beacons, Data Provider, Media Provider and Advertiser data) can be stored in association with a partner labeled as a “source of traffic.” Whether the traffic redirection comes via an image or a JavaScript can be stored. The various values relating to the type of each traffic source can be used to determine what ID mapping setting is available for the traffic source, and identify any limitations depending on the type. The fields associated with the traffic sources and with the partners to ID map with can be query-able through a data mine interface.

### Exemplary Administrative Panel for Cross Domain Synchronization

An administrative panel/console to configure the cross domain synchronization module may be accessible by privileged users of an audience platform, such as the audience platform 102. For example, the administrative panel can be referred to as “ID Mapping settings.” In some embodiments, the link to and functionality of the administrative panel can be only exposed to a list of internal users who are the only one able to view/edit these settings.

When the link ID Mapping settings is clicked, the ID Mapping Settings display page can be displayed. On this page, there can be a search functionality and a filter functionality to identify entities in the system environment. By default, this page will show a Publishers tab as selected, which lists all the Publishers known to the audience system.

### Configurable Fields/Parameters for the Publishers Tab

The Publishers tab can enable editing of identifier mapping settings specific to each publisher. When an administrative user selects only 1 Publisher entry to edit, the Edit ID Mapping for Publishers page can display the existing settings for the selected publisher. When an administrative user has access to view and edit this flow, the administrative user will be able to edit/change the values in the fields. When an administrative user selects more than 1 Publisher entry to edit, the Edit ID Mapping for Publishers page can display all the default settings only for every field, and list all the Publishers selected as the Publishers whose setting will be affected. In this case, when the administrative user clicks on a “Save” button to save the new settings (e.g., via a mouse or a touchscreen), there can then be a popup that states: “Please confirm your changes, these settings will apply to all the listed Publishers regardless of previous Publisher ID Mapping settings.” The administrative user then must choose to Confirm to apply the bulk setting change or Cancel to go back to Edit ID Mapping for Publishers page.

The following are configurable fields and/or parameters for cross domain synchronization between an audience platform and an audience data partner that is a publisher:

Number of ID Mappings allowed: Valid values of this field can be any numeric number or the field can be blank. If the field is blank, this means that there is no maximum limit of number of re-directs for this audience data partner. In some embodiments, by default this field can remain blank for every Publisher.

Allow ID mappings across cookie spaces: This field can be a checkbox for “Yes allow across cookie spaces”. In some embodiments, by default this field can remain checked for every existing Publisher.

ID Mapping stored by: This field can be a required field. In some embodiments, by default every existing Publisher in will have a value indicating that the audience data partner will store the ID mapping (e.g., the matching table/linkage file). Whenever an audience data partner stores the ID mapping, the ID syncing URL can ‘fire and forget’. Whenever the audience platform is selected to store the partner's ID mapping, the ID syncing URL is called and the audience platform must wait for a reply to write the mapping into the audience user's profile.

Allow ID Mappings with: This can be a multi-selectable checkbox. The values of this field can be, for example, RTB Exchanges, Non-RTB Exchanges, Private domains, Media Providers and Data Providers. In some embodiments, each Publisher's setting includes an “Ad serving options,” including a checkbox for “Disable third-party data collection.” In some embodiments, when the “Disable third party data collection” is not checked, then by default for such publisher, all the values in the Allow ID Mappings with field will be selected. When the existing Publisher's setting for Ad serving options is checked for Disable third party data collection, then by default for these publishers, none of the values in the Allow ID Mappings with field will be selected.

Refresh ID Mapping after: This field can be a required field. This field can be editable, and in various embodiments, cannot be blank. This field can represent the TTL of the ID Mapping. Valid values of this field can be any numeric number. By default, this field can have the existing value for every Publisher. Any new Publishers created added onto the system environment of the audience platform can have a default value, such as 30, for this field.

Class of partner: This field is optional. All existing Publishers can have value of “RTB Exchange” for this field. However, the administrative user can edit the field to correctly indicate the class of the audience data partner. When a new Publisher is created, the new publisher can also have the value “RTB Exchange” for this field.

ID Mapping URL http: This field can be a text field and can be blank. This field can represent the http URL for ID mapping calls initiated by the audience platform to call. This field is the non-secure, http ID mapping URL. Any known http ID Mapping URLs for the existing Publishers can be displayed here as an option. By default when a new Publisher is created this field can be blank.

ID Mapping URL https: This field can be a text field and can be blank. This field can represent the https URL for ID mapping calls initiated by the audience platform to call. This field can be the secure, https ID mapping URL. Any known https ID Mapping URLs for the existing Publishers can be displayed here as an option. By default when a new Publisher is created this field can be blank.

### Configurable Fields/Parameters for the Inventory Source

The administrative panel can include an Inventory sources tab. If an administrative user clicks on the Inventory sources tab, a list of all the inventory sources in the audience platform can be displayed. On this page there can be a search functionality and filter functionality that works similar to the Publishers tab.

Inventory sources are defined as RTBs with private seats. In various embodiments, each seat exists as a separate Publisher entry in the administrative panel, but the ID Mapping Setting is controlled at the RTB level regardless which seat it is for. For example, AdX, a RTB exchange, can be an Inventory Source. AdX can be mapped to the various AdX Publisher entries. The setting for a publisher entry of the AdX can apply for other publisher entries for the AdX (propagated to every linked AdX Publisher). Additional Inventory sources in the current system include private seat partners, such as the Right Media Exchange (RMX).

ID mapping setting for an inventory source can be edited as a whole. For example, when an administrative user selects only 1 Inventory source entry to edit, the Edit ID Mapping for Inventory source page can display the existing settings for the selected Inventory source. When an administrative user has access to view and edit this flow, the administrative panel enables the user to edit/change the values in the fields.

If an administrative user selects more than 1 Inventory source entry to edit, the Edit ID Mapping for Inventory source page can display all the default settings only for every field, and list all the Inventory source selected as the Inventory Sources whose setting will be affected.

In this case, when the user clicks on Save to save the new settings, there can be a popup that says “Please confirm your changes, these settings will apply to all the listed Inventory sources regardless of previous Inventory source ID Mapping settings.” The user can choose to a Confirm button to apply the bulk setting change or a Cancel button to go back to Edit ID Mapping for Inventory source page.

The following are configurable fields and/or parameters for cross domain synchronization between an audience platform and an audience data partner that is an inventory source:

ID Mapping URL http: This field can be a text field and can be blank. This field represents the http URL for ID mapping calls initiated by the audience platform to call. This field is the non-secure, http ID mapping URL. Any known http ID Mapping URLs for the existing Publishers can be displayed in this field. By default when a new Publisher is created this field can be blank.

ID Mapping URL https: This field can be a text field and can be blank. This field represents the https URL for ID mapping calls initiated by the audience platform to call. This field is the secure, https ID mapping URL. Any known https ID Mapping URLs for the existing Publishers can be displayed in this field. By default when a new Publisher is created this field can be blank.

### Configurable Fields/Parameters for the Beacon Tab

The administrative panel can include a Beacons tab. If the administrative user clicked on Beacons tab, a list of all the beacons known to the audience platform, such as the audience platform functioning as a media platform to facilitate media buying, in the system environment is displayed. The Beacons tab page can include a search functionality and filter functionality that works similar to the Publisher's tab.

When an administrative user selects only 1 Beacon entry to edit, the Edit ID Mapping for Beacon page can display the existing settings for the selected Beacon. If an administrative user has access to view and edit this flow, the administrative user can then edit/change the values in the fields. If an administrative user selects more than 1 Beacon entry to edit, the Edit ID Mapping for Beacon page can display all the default settings only for every field, and list all the Beacon selected as the Beacons whose setting will be affected.

In this case, when the administrative user clicks on Save to save the new settings, there can be a popup that says “Please confirm your changes, these settings will apply to all the listed Beacons regardless of previous Beacon ID Mapping settings.” The administrative user can then choose to a Confirm button to apply the bulk setting change or a Cancel button to go back to Edit ID Mapping for Beacon page.

The following are configurable fields and/or parameters for cross domain synchronization between an audience platform and an audience data partner that is a data beacon:

Number of ID Mappings allowed: Valid values of this field can be any numeric number or the field can be blank. If the field is blank, this means that there is no maximum limit of number of re-directs for this partner. By default, this field can remain blank for every existing Beacon.

Allow ID mappings across cookie spaces: This field can be a checkbox next to a text statement of “Yes allow across cookie spaces”. By default, this field can remain checked for every existing Beacon known in the online advertisement system environment implementing cross domain synchronization.

ID Mapping stored by: This field can be a required field. By default, every existing Beacon can have value of “Partner”. Whenever the audience data partner stores the ID mapping, the ID syncing URL can ‘fire and forget’. Whenever the audience platform stores the partner's ID mapping, the ID syncing URL is called and the audience platform must wait for a reply to write the mapping into the audience user's profile.

Allow ID Mappings with: This can be a multi-selectable checkbox. The values of this field can be RTB Exchanges, Non-RTB Exchanges, Private domains, Media Providers and/or Data Providers. If the existing Beacon's setting for Ad serving options is not checked for “Disable third party data collection”, then by default for these Beacons, all the values in the Allow ID Mappings with field will be selected. If the existing Beacon's setting for Ad serving options is checked for “Disable third party data collection”, then by default for these Beacons, none of the values in the Allow ID Mappings with field will be selected.

### Configurable Fields/Parameters for the Data Provider Tab

The administrative panel can include a Data Providers tab. If the administrative user clicked on Data Providers tab, a list of all the data providers known to the audience platform in the system environment is displayed. The Data Providers tab can include a search functionality and filter functionality that works similar to the Publishers tab.

When an administrative user selects only 1 Data Providers entry to edit, the Edit ID Mapping for Data Providers page can display the existing settings for the selected Data Providers. If an administrative user has access to view and edit this flow, the administrative user will be able to edit/change the values in the fields. If an administrative user selects more than 1 Data Providers entry to edit, the Edit ID Mapping for Data Providers page can display all the default settings only for every field, and list all the Data Providers selected as the Data Provider whose setting will be affected.

In this case, when the administrative user clicks on a “Save” button to save the new settings, there can be a popup that says “Please confirm your changes, these settings will apply to all the listed Data Providers regardless of previous Data Providers ID Mapping settings.” The administrative user can choose to a Confirm button to apply the bulk setting change or a Cancel button to go back to Edit ID Mapping for Data Providers page.

The following are configurable fields and/or parameters for cross domain synchronization between an audience platform and an audience data partner that is a data provider:

ID Mapping option that is a dropdown box: The values of this field can be selected from “No ID mapping allowed”, “In same cookie space only”, and “Across cookie spaces allowed”. This field can default to “No ID mapping allowed” for every existing Data Provider unless otherwise noted.

Number of ID Mappings allowed: This field can be blank. Valid values of this field can be any positive integer values greater than 0, or blank. If the field is blank, this represents that there is no maximum limit of number of re-directs for this partner. By default, this field can remain blank for every existing Data Provider.

ID Mapping stored by: This field can a required field. By default, every existing Data Provider can have a value indicating the audience platform implementing the cross domain synchronization. Whenever the data partner is selected to store the ID mapping, the ID syncing URL can ‘fire and forget’. Whenever the audience platform stores the partner's ID mapping, the ID syncing URL is called and the audience platform can wait for a reply to write the mapping into the audience user's profile.

Allow ID Mappings with: This can be a multi-selectable checkbox. The values of this field can be selected from RTB Exchanges, Non-RTB Exchanges, Private domains, Media Providers or Data Providers. The default for every existing Data Provider is to leave all the values unchecked for this field.

Refresh ID Mapping after: This field can be a required field (i.e., can not be blank). This field represents the TTL of the ID Mapping. Valid values of this field can be any numeric number. By default, every existing Data Provider can have a default value of 7. This field can be used for checking if there was an ID sync call (i.e., cross-domain synchronization) with this Data Provider within the TTL. As with existing functionality, if there was an ID sync call within the TTL for this partner, the ID sync for this partner will not be called.

Class of partner: This field is optional. All existing Data Providers can have value “Data Provider” for this field. When a new Data Provider is created, the new Data Provider can also have value Data Provider for this field.

ID Mapping URL http: This field can be a text field and can be blank. This field represents the http URL for ID mapping calls initiated by the audience platform to call. This field is the non-secure, http ID mapping URL. Any known http ID Mapping URLs for the existing Data Provider can be displayed here. By default when a new Data Provider is created, this field can be blank.

ID Mapping URL https: This field can be a text field and can be blank. This field represents the https URL for ID mapping calls initiated by the audience platform to call. This field is the secure, https ID mapping URL. Any known https ID Mapping URLs for the existing Data Provider can be displayed in this field. By default when a new Data Provider is created, this field can be blank.

### Configurable Fields/Parameters for the Media Provider Tab

The administrative panel can include a Media Provider tab. If the administrative user clicked on Media Providers tab, a list of all the media providers can be displayed. On this page there can be a search functionality and filter functionality that works similar to the Publishers tab.

When an administrative user selects only 1 Media Providers entry to edit, the Edit ID Mapping for Media Providers page can display the existing settings for the selected Media Providers. If an administrative user has access to view and edit this flow, the administrative user will be able to edit/change the values in the fields. If an administrative user selects more than 1 Media Providers entry to edit, the Edit ID Mapping for Media Providers page can display all the default settings only for every field, and list all the Media Providers selected as the Data Provider whose setting will be affected.

In this case, when the administrative user clicks on a “Save” button to save the new settings, there will be a popup that says “Please confirm your changes, these settings will apply to all the listed Media Providers regardless of previous Media Providers ID Mapping settings.” The administrative user can choose to a Confirm button to apply the bulk setting change or a Cancel button to go back to Edit ID Mapping for Media Providers page.

The following are configurable fields and/or parameters for cross domain synchronization between an audience platform and an audience data partner that is a media provider:

ID Mapping option that is a dropdown box: The values of this field can be selected from “No ID mapping allowed”, “In same cookie space only”, and “Across cookie spaces allowed”. By default, this field can default to “Across cookie spaces allowed” for every existing Media Provider unless otherwise noted.

Number of ID Mappings allowed: This field can be blank. Valid values of this field is any positive integer values greater than 0, or blank. If the field is blank, this represents that there is no maximum limit of number of re-directs for this partner. By default, this field can remain blank for every existing Media Provider unless otherwise noted.

ID Mapping stored by: This field can be a required field. By default, every existing Media Provider can have a value indicating that the ID mapping is to be stored on the audience platform. Whenever the audience data partner stores the ID mapping, the ID syncing URL can ‘fire and forget’. Whenever the audience platform stores the partner's ID mapping, the ID syncing URL is called and the audience platform waits for a reply to write the mapping into the audience user's profile.

Allow ID Mappings with: This can be a multi-selectable checkbox. The values of this field can be selected from RTB Exchanges, Non-RTB Exchanges, Private domains, Media Providers and Data Providers. The default for every existing Media Provider is to leave all the values unchecked for this field.

Refresh ID Mapping after: This field can be a required field (i.e., cannot be blank). This field can be editable. This field represents the TTL of the ID Mapping. Valid values of this field is any numeric number. By default, every existing Media Provider can have a default value of 7. This field can be used for checking if an ID sync call with this Media Provider occurred within the TTL period. If an ID sync call within the TTL period occurred for this partner, the ID sync for this partner will not be called.

Class of partner: This field is optional. All existing Media Providers in the audience platform can have a value of “Media Provider” for this field, unless otherwise noted. When a new Media Provider is created, the new Media Provider can also have a value of “Media Provider” for this field.

ID Mapping URL http: This field can be a text field and can be blank. This field represents the http URL for ID mapping calls initiated by the audience platform to call. This field is the non-secure, http ID mapping URL. Any known http ID Mapping URLs for the existing Media Provider can be displayed here. By default, when a new Media Provider is created, this field can be blank.

ID Mapping URL https: This field can be a text field and can be blank. This field represents the https URL for ID mapping calls initiated by the audience platform to call. This field is the secure, https ID mapping URL. Any known https ID Mapping URLs for the existing Media Provider can be displayed in this field. By default when a new Media Provider is created, this field can be blank.

### Configurable Fields/Parameters for the Advertiser Data Tab

If the administrative user clicked on Advertiser Data tab, a list of all the known Advertiser Data Contracts in the audience platform is displayed. On this page, there can be a search functionality and filter functionality that works similar to Publishers tab. When an administrative user selects only 1 Advertiser Data entry to edit, the Edit ID Mapping for Advertiser Data page can display the existing settings for the selected Advertiser Data. If an administrative user has access to view and edit this flow, the administrative user will be able to edit/change the values in the fields. If an administrative user selects more than 1 Advertiser Data entry to edit, the Edit ID Mapping for Advertiser Data page can display all the default settings only for every field, and list all the Advertiser Data selected as the Data Provider whose setting will be affected.

In this case, when the administrative user clicks on a “Save” button to save the new settings, there can be a popup that says “Please confirm your changes, these settings will apply to all the listed Advertiser Data regardless of previous Advertiser Data ID Mapping settings.” The administrative user can choose to click a Confirm button to apply the bulk setting change or a Cancel button to go back to Edit ID Mapping for Advertiser Data page.

The following are configurable fields and/or parameters for cross domain synchronization between an audience platform and an audience data partner that is an advertiser:

ID Mapping option that is a dropdown box: The values of this field can be “No ID mapping allowed” or “In same cookie space only”. By default, this field can default to “No ID mapping allowed” for every existing Advertiser Data Contract.

Number of ID Mappings allowed: This field can be blank. Valid values of this field is any positive integer values greater than 0, or blank. If the field is blank, this represents that there is no maximum limit of number of re-directs for this partner. By default, this field can remain blank for every existing Advertiser Data Contract.

### Configurable Fields/Parameters for Private Domains

There can be a Class of Partner field that has value “Private Domains.” For example, private domains can include Experian's audience IQ (AIQ) system and Accuen's audience intelligence platform (AIP). Like the disclosed audience platform, the AIQ and the AIP systems can also be data management systems. In some embodiments, the systems can be hosted on a web server shared by the disclosed audience platform. Hence in these examples, the ID sync URL to call can be said to the AIP system or the AIQ system. This class of partner does not have to be displayed in the audience platform administrative panel.

In some embodiments, the web server of the audience platform can host web domains that the ID syncing will happen without noticeable latency. ID mapping done within these “Private Domains” class of partners would be more efficient than any other class of partners, where the partners are external to the audience platform.

The following are configurable fields and/or parameters for cross domain synchronization between an audience platform and a private domain partner:

For each “Private Domains” partners, there can be an additional field for Refresh ID Mapping after. This field can be a required field (i.e., cannot be blank). This feel represents the TTL of the ID Mapping. Valid values of this field is any numeric number. This field does not have to be surfaced in the audience platform console. By default, the Refresh ID Mapping after value for both examples of “Private Domains” partners (AIP and AIQ) can have the default value of 7 (i.e., 7 days). If an ID sync call within the TTL period occurred for this partner, the ID sync for this partner will not be called.

ID Mapping URL http: This field can be a text field and can be blank. This field represents the http URL for ID mapping calls initiated by the audience platform to call. This field is the non-secure, http ID mapping URL. Any known http ID Mapping URLs for the existing Private Domains can be surfaced here. By default when a new Private Domain is created this field can be populated with the ID mapping URL.

ID Mapping URL https: This field can be a text field and can be blank. This field represents the https URL for ID mapping calls initiated by the audience platform to call. This field is the secure, https ID mapping URL. Any known http ID Mapping URLs for the existing Private Domains will be surfaced here. By default when a new Private is created this field should be populated with the ID mapping URL.

### Configurable Fields/Parameters for Non-Rtb Exchanges

Currently impression traffic received at a demand-side platform may be used to send an audience user's behavior information to specific audience data partners. These current partners, for example, include RMX and AdX. User behavior information routed through the demand-side platform, such as the Turn Media Platform, can be configured under a “Behaviors” sub-tab under a Media Platform Data Tab. In this case, the value of for the field Class of partner can be set as “Non-RTB Exchanges.” Any new behavior created with the value “Create new RM pixel” selected can also have the value “Non-RTB Exchanges” in the field Class of partner.

For each Non-RTB Exchanges partner, there can be an additional field for Refresh ID Mapping after. This field can be a required field. The field represents the TTL of the ID Mapping. Valid values of this field is any numeric number. This field does not have to be surfaced in the administrative panel/console. By default, the Refresh ID Mapping after value for all “Non-RTB Exchanges” partners can have the default value of 7 (for 7 days). If an ID sync call occurs within the TTL period for a partner, the ID sync for this partner will not be called.

Cross Domain Synchronization with Rtb Exchanges

If an audience data partner has a limit on the number of calls and the limit is less than all the RTB Exchange partners we need to call, the RTB exchanges can be called in a randomized order until the limit is reached. The randomized order ensures a fair distribution of information to the RTB exchanges across all traffic should a limit be a factor for a traffic source partner.

Cross Domain Synchronization with Media Providers

For media provider integrations, container tag pixel can be used also as ID sync pixel. In some embodiments of a control console/administrative panel of the data management platform, a “base pixel” value is required to be set for any media provider. The data management platform can always redirect to the base pixel URL when a container tag pixel is called. However, in various embodiments, this is not necessary for media providers who integrated to the data management platform via server-to-server communication. In these cases, the container tags can be used only for ID mapping purposes. The above implementation is advantageous because not having to redirect to the media provider's base pixel URL can reduce the network resources wasted by the data management platform.

In the administrative panel under a “Base Pixel” tab of the Media Provider Detail screen, the field of “ID mapping only?” can be included. This field can be a checkbox for “Container tag will only be used for ID mapping”. When this checkbox is selected, the Base pixel will not be called when container tag pixel is fired. By default, this field can remain un-checked for every existing Media Provider in the data management platform. In various embodiments, this field is only expose to a list of internal admin users who will be the only one able to view/edit such field.

FIG. 6 is a block schematic diagram that depicts a machine in the exemplary form of a computer system 600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken. The computer system 600 is intended to illustrate a hardware device on which any of the modules and components depicted in the examples of FIGS. 1-3 (and any other modules and/or components described in this specification) can be implemented. As shown, the computer system 600 includes a processor 602, memory 604, non-volatile memory 606, and a network interface 608. Various common components (e.g., cache memory) are omitted for illustrative simplicity. The computer system 600 can be of any applicable known or convenient type, such as a personal computer (PC), server-class computer or mobile device (e.g., smartphone, card reader, tablet computer, etc.). The components of the computer system 600 can be coupled together via a bus and/or through any other known or convenient form of interconnect.

One of ordinary skill in the relevant art will recognize that the terms “machine-readable (storage) medium” or “computer-readable (storage) medium” include any type of device that is accessible by the processor 602. The memory 604 is coupled to the processor 602 by, for example, a bus 610. The memory 604 can include, by way of example but not limitation, random access memory (RAM), such as dynamic RAM (DRAM) and static RAM (SRAM). The memory 604 can be local, remote, or distributed.

The bus 610 also couples the processor 602 to the non-volatile memory 606 and drive unit 612. The non-volatile memory 606 may be a hard disk, a magnetic-optical disk, an optical disk, a read-only memory (ROM), such as a CD-ROM, Erasable Programmable Read-Only Memory (EPROM), or Electrically Erasable Programmable Read-Only Memory (EEPROM), a magnetic or optical card, or another form of storage for large amounts of data. The non-volatile storage 606 can be local, remote, or distributed.

The modules described in FIGS. 1-3 may be stored in the non-volatile memory 606, the drive unit 612, or the memory 604. The processor 602 may execute one or more of the modules stored in the memory components.

The bus 610 also couples the processor 602 to the network interface device 608. The interface 608 can include one or more of a modem or network interface. A modem or network interface can be considered to be part of the computer system 600. The interface 608 can include an analog modem, ISDN modem, cable modem, token ring interface, satellite transmission interface (e.g. “direct PC”), or other interfaces for coupling a computer system to other computer systems.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

What is claimed is:

1. A computer-implemented method of audience ID synchronization in a data management platform for online advertising campaigns, the method comprising:
receiving, at the data management platform, a first redirect traffic from a first domain associated with the data management platform during a first browser session, in response to a web browser loading an embedded web object on a web page of the first domain;
identifying a consumer user by searching through a cookie cache of the web browser to determine whether an unity identifier has been assigned in the cookie cache by the data management platform, wherein the consumer user is a potential target to observe an advertisement to be presented by the online advertisement campaigns;
in response to determining that an unity identifier has not been assigned to the consumer user, generating a cookie containing a new unity identifier and dropping the cookie into the cookie cache of the web browser;
updating a matching table of identifiers of the consumer user with the new unity identifier, wherein the identifiers are used to maintain an audience user profile to assist decision-making process of the online advertisement campaigns, and wherein the unity identifier is a single identifier used in the matching table to transfer knowledge of online linkages between entities observed by various web domains or data management platforms; and
synchronizing the identifiers of the consumer user with a partner platform from the data management platform via the matching table stored in the data management platform, wherein the matching table includes first user identifiers corresponding to first domains associated with the data management platform and second user identifiers corresponding to second domains associated with the partner platform.

2. The method of claim 1, wherein the synchronizing is via a server-to-server message.

3. The method of claim 1, wherein the synchronizing is via a run-time ID sync call in response to receiving the first redirect traffic.

4. The method of claim 1, wherein the partner platform is another data management platform.

5. The method of claim 1, wherein the first domains and the second domains includes a data provider, a media provider, an advertiser, a demand-side platform, or any combination thereof.

6. A computer-implemented method of audience ID synchronization in a data management platform for online advertisement campaigns, the method comprising:
receiving a first redirect traffic from a first domain associated with the data management platform during a first browser session of a consumer user, the first browser session established by a web browser;
identifying the consumer user by searching through a cookie cache of the web browser to determine whether an unity identifier known to the data management platform is found within the cookie cache, wherein the consumer user is a potential target to observe an advertisement to be presented by the online advertisement campaigns;
determining the unity identifier associated with the consumer user from either the unity identifier identified into the cookie cache or generating a new unity identifier when the unity identifier is determined not to be assigned to the consumer user in the cookie cache;
updating a matching table of identifiers of the consumer user with the new unity identifier, wherein the identifiers are used to maintain an audience user profile to assist decision-making process of the online advertisement campaigns, and wherein the unity identifier is a single identifier used in the matching table to transfer knowledge of online linkages between entities observed by various web domains or data management platforms; and
synchronizing the identifiers of the consumer user with a partner platform from the data management platform via the matching table stored in the data management platform.

7. The computer-implemented method of claim 6, wherein synchronizing the identifiers is performed during the first browser session of the web browser.

8. The computer-implemented method of claim 6, wherein synchronizing the identifiers is performed in batch after termination of the first browser session.

9. The computer-implemented method of claim 6, wherein updating the matching table comprises:
waiting for a response from the partner platform; and
writing an audience identifier corresponding to the consumer user from the response of the partner platform to the matching table stored on the data management platform.

10. The computer-implemented method of claim 6, wherein synchronizing the identifiers further comprises transmitting the unity identifier to the partner platform to cause the partner platform to update the unity identifier to an instance of the matching table stored on the partner platform.

11. The computer-implemented method of claim 6, wherein the synchronizing of the identifiers is throttled to control an overall traffic load towards the partner platform.

12. The computer-implemented method of claim 6, further comprising receiving an update to the matching table from a private domain client, wherein the update includes at least an audience identifier of the consumer user from a different cookie space as the unity identifier.

13. The computer-implemented method of claim 12, further comprising storing a platform map of partner platform ID in different cookie spaces.

14. The computer-implemented method of claim 6, further comprising aggregating known consumer users from the matching table to calculate an audience reach coverage of the data management platform.

15. The computer-implemented method of claim 14, further comprising generating and displaying a monitor page illustrating the audience reach organized by cookie spaces associated different web domains.

16. The computer-implemented method of claim 15, wherein the cookie spaces are each associated with one or more web domains and accessible only by the associated one or more web domains.

17. The computer-implemented method of claim 15, wherein the monitor page captures whether the partner platform stores an audience identifier assigned by the data management platform or the data management platform stores an audience identifier assigned by the partner platform.

18. The computer-implemented method of claim 15, wherein the monitor page captures whether the partner platform stores an audience identifier assigned by the data management platform or the data management platform stores an audience identifier assigned by the partner platform.

19. The computer-implemented method of claim 15, further comprising generating a notification when a threshold percentage of the identifiers have not been synchronized with the partner platform.

20. The computer-implemented method of claim 6, wherein each entry of the matching table includes an accessibility level tag, wherein the accessibility level tag determines if an audience identifier of the consumer user can be copied without restriction, can be copied within the data management platform, or cannot be copied.

21. The computer-implemented method of claim 6, wherein the matching table linking the identifiers of the consumer user is stored in the audience user profile associated with the consumer user.

22. A data management platform comprising:
a network interface adapted to receive a first redirect traffic from a first domain associated with the data management platform during a first browser session, in response to a web browser loading an embedded web object on a web page of the first domain; and
one or more processors configured to:
identify the consumer user by searching through a cookie cache of the web browser to determine whether an unity identifier has been assigned in the cookie cache by the data management platform, wherein the consumer user is a potential target to observe an advertisement to be presented by online advertisement campaigns;
in response to determining that unity identifier has not been assigned to the consumer user, generate a cookie containing a new unity identifier and drop the cookie into the cookie cache of the web browser;
update a matching table of identifiers of the consumer user with the new unity identifier, wherein the identifiers are used to maintain an audience user profile to assist decision-making process of the online advertisement campaigns, and wherein the unity identifier is a single identifier used in the matching table to transfer knowledge of online linkages between entities observed by various web domains or data management platforms; and
synchronize the identifiers of the consumer user with a partner platform from the data management platform through the network interface via the matching table stored in the data management platform, wherein the matching table includes first user identifiers corresponding to first domains associated with the data management platform and second user identifiers corresponding to second domains associated with the partner platform.
